(19) United States
(12) Patent Application Publication
(10) Pub. No.: US 2024/0404718 A1
(43) Pub. Date: Dec. 5, 2024

(54) METHOD FOR PERFORMING REAL-TIME PROBABILISTIC SAFETY ASSESSMENTS FOR NUCLEAR POWER PLANTS

(71) Applicant: KING FAISAL UNIVERSITY, Al-Ahsa (SA)

(72) Inventors: Muhammad ZUBAIR, Al-Ahsa (SA); Muhammad AAMIR, Al-Ahsa (SA)

(21) Appl. No.: 18/205,701

(22) Filed: Jun. 5, 2023

(51) Int. Cl. G21C 17/00; G06N 7/01

(52) U.S. Cl. CPC G21C 17/00; G06N 7/01

(57) ABSTRACT

The method for performing real-time probabilistic safety assessments for nuclear power plants is an artificially intelligent, self-updating Living probabilistic safety assessment (PSA). An initial probabilistic safety assessment model is developed for a particular nuclear power plant. A simulation of the nuclear power plant is developed, and real-time parameters are also measured from the nuclear power plant. Feature extraction is performed on the results of the probabilistic safety assessment model combined with corresponding results from the simulation and the measured real-time parameters. A set of system state labels is generated, and an updated probabilistic safety assessment model is developed using the extracted features and the set of system state labels as training data for a machine learning algorithm. The initial probabilistic safety assessment model is then replaced with the updated probabilistic safety assessment model and the process begins again using the updated probabilistic safety assessment model.

### BACKGROUND

### Field

The disclosure of the present patent application relates to assessing risks associated with nuclear power plant operations, and particularly to a method for performing a real-time probabilistic safety assessment on a nuclear power plant.

### Description of Related Art

Probabilistic safety assessments (PSAs) are regularly performed for nuclear power plants (NPPs) around the world. PSAs are used for a wide variety of purposes, including assessing compliance with regulatory requests to support a safety case, identification and understanding key plant vulnerabilities, and analysis of the impact of proposed design or operational changes. A nuclear power plant PSA analyzes the risk associated with operating the plant, expressed in terms of various metrics related to the different levels of damage to the plant, such as core damage frequency (CDF), or damage to the environment (e.g., societal or individual risk). The analysis is performed using a logical and systematic approach that makes use of realistic assessments of the performance of the equipment and plant personnel as a basis for the calculations.

PSAs have the potential to produce an understanding of the inherent risk of operating the plant over a much wider range of conditions than the traditional deterministic methods, which generally define what is assumed to be a bounding set of fault conditions. Further, the adoption of conservative assumptions relating to plant and system performance is an accepted approach to addressing uncertainty when performing these deterministic analyses. The combination of considering a limited number of faults and a conservative approach to the analysis of each fault can produce inappropriate, or worse, misleading insights, thus decisions based on these types of analyses might not always be the most appropriate for reducing plant risk.

By using PSAs, which consider a much wider range of faults, take an integrated look at the plant as a whole (i.e., system inter-dependencies), and use realistic criteria for the performance of the plant and systems, more risk-informed decisions can be made. The PSA, therefore, is a useful tool for safety management and its use can increase the level of safety by providing information not available from the evaluation of a limited set of design basis events.

The extent to which PSA results can contribute to a decision depends on the level of detail of the PSA model, its quality, its completeness, and on whether the subject of the decision is amenable to analysis using a PSA. Thus, when performing a PSA, it is very important to have an appreciation for what the PSA may be needed or intended for in order to define its requirements or to perform it in a way that allows it to be modified to support possible future applications. For certain specific and limited applications, a relatively simple PSA model may be adequate. However, for other applications, such as when a PSA is to be used as a day-to-day tool for decision making at NPPs, all aspects of the model are brought into play and a detailed, comprehensive model is necessary. As the understanding of plant performance improves, and the weaknesses, limitations and technical difficulties associated with the PSA are progressively remedied, the quality and usefulness of the PSA will increase.

Whatever the level of detail adopted, the model must reflect the current status of the plant. Thus, if the PSA is to be of continuing use in the enhancement and understanding of plant safety, it must be updated or modified when necessary to reflect changes to the plant and its operating practices, and to reflect improvements in methods. This has led to the concept of the Living PSA (LPSA). A Living PSA is a PSA of the plant which is updated as needed to reflect the current design and operational features and is documented in such a way that each aspect of the model can be directly related to existing plant information, plant documentation or the analysts' assumptions in the absence of such information.

In a typical plant, an LPSA works in conjunction with a safety/risk monitor, which is a plant specific real-time analysis tool used to determine the instantaneous risk based on the actual status of the systems and components. At any given time, the safety monitor reflects the current plant configuration in terms of the known status of the various systems and/or components; e.g., whether there are any components out of service for maintenance or tests. The safety monitor model is based on, and is consistent with, the LPSA. It is updated with the same frequency as the LPSA. The safety monitor is used by the plant staff in support of operational decisions.

Although the LPSA and the safety/risk monitor work in conjunction, they are separate entities. The LPSA is a comprehensive model which provides a considerable amount of information on many aspects of plant design and operation. In its complete form, and for its solution, assumptions are made about maintenance and test activities over the year, as well as the random occurrence of initiating events. Its primary use is to predict the core damage frequency (CDF) over the life of the plant and enable the utility to have a risk perspective in long-term planning of design and operational changes. The safety/risk monitor, on the other hand, is designed to show the current risk state based on the actual plant configuration and tests in progress at any given time. Its primary use, therefore, is to enable maintenance and test activities to be performed on a risk-informed basis. This is done by either having a target, such as, in some cases, core damage probability (CDP) for any configuration in which the CDF is above a given threshold, or minimizing the risk when such a risk target or criteria do not exist.

Present PSAs are categorized by levels. A Level 1 PSA typically has the following objectives: estimation of core damage frequency; identification of the initiating events and dominant accident sequences with the highest contribution to the core damage; identification of weaknesses or vulnerabilities in plant systems' design and operation; and preparing input for PSA applications and decision making. It is noted that a PSA is, ultimately, simply a model. The typical PSA model is developed from five basic sources of information and stages, which are then integrated into the final plant model. As illustrated in FIG. 2, a typical Level 1 PSA 100 uses the following information sources and stages: a collection of plant and operational information 102; initiating event analysis and accident sequences development 104; event tree and fault tree development 106; data preparation and analysis 108; and human reliability analysis 110. As will be discussed in greater detail below, a data fusion process 112 is used to merge each of the above sources and stages to yield the PSA results 114, which at least include the CDF 116. The CDF 116 is typically the primary objective of performing a PSA.

The collection of plant and operational information 102 provides the basis for accurate representation of the plant in the probabilistic model. As examples, this collection of information may include plant safety case/technical safety justification reports, technical specifications and operational procedures, piping and instrumentation diagrams (PIDS), thermal-hydraulics analysis reports, lists of interlocks, accident mitigation procedures, staff training manuals and programs, control room logs, maintenance records, statistical data on component failures and incident data, and component exposure times, generic information sources, etc.

An initiating event (IE) is any event that disrupts the normal conditions in the plant and leads to the need for reactor subcriticality and decay heat removal. Typical examples of IEs include loss of coolant accidents (LOCAs) (i.e., events that disrupt the plant by causing a breach in the primary coolant system with loss of core coolant inventory), transients (i.e., events that disrupt the heat balance of the plant and lead to the automatic or manual reactor trip), and special initiating events, which are failures of support systems which cause a plant trip and degradation of an accident mitigation system. The main objectives of the initiating events analysis 104 are: to identify a complete set of the events that interrupt normal plant operation and that require successful mitigation to prevent core damage (all significant contributors to core damage must be identified); and to group the identified initiating events so as to facilitate the efficient modelling of plant response and initiating events frequency assessment while providing sufficient resolution regarding modelling of accident sequences. Events included in the same group have similar mitigation requirements or are bounded by the limiting mitigation requirements for the representative initiating event for the group. Initiating events are broadly categorized into two categories: internal initiating events and external initiating events. Internal initiating events are system and equipment malfunctions inside the plant. The loss of offsite electrical power (i.e., loss of grid) is analyzed along with internal events. External initiating events include earthquakes, extreme meteorological conditions, aircraft crashes, etc. Internal flooding and internal fire events are conventionally also treated in PSA studies as external events.

For accident sequence analysis 104, “event trees” are the logic models from which the accident sequences are derived. In general, separate systemic event trees are constructed for each initiating event group. Each event tree will have a different structure since the initiating events were grouped according to the mitigating requirements, i.e., different mitigating requirements result in different tree structures. Headings for the event trees correspond to the systems responding to the initiating event. Typically, only front-line systems appear on the trees. System dependencies and dependencies arising from the phenomenological aspects of the accident are reflected in the tree structure.

Fault trees (FTs) are a graphical and analytical method where an undesired state of a system is specified, and the system is then analyzed in the context of its operation to find all possible ways in which the undesired event can occur. In a PSA, FTs are used to model the failure of events in the accident sequence event trees. Fault trees are used to model failures of the system success criteria and provide the link between the plant safety functions and failures of the actual plant systems, equipment, and human actions. The combination of event trees and fault trees provides a comprehensive and detailed representation of the plant's safety logic. The modelling approaches used are typically either large event tree/small fault tree or small event tree/large fault tree.

The objective of the data preparation analysis stage 108 is to provide quantitative information needed to estimate the core damage frequency. Specifically, this typically includes the estimation of: initiating event frequencies; component reliability parameters (i.e., failure rates and failure on demand probabilities); component unavailabilities due to testing and maintenance; component unavailabilities due to common cause failures (CCFs); and human error probabilities (analyzed separately in the human reliability analysis). Derived information about incidents and component failures is primarily taken from basic sources, such as licensee event reports, control room logs and maintenance work orders. Typically, since initial (raw) information for development of data on IE frequencies and component reliability parameters is scarce, data from similar types of reactors are used. Additional sources include incident data available from regulatory agency reports, real world experience of NPP units, international databases, etc.

Human reliability analysis (HRA) 110 is the assessment of the risk associated with plant personnel interactions and, in particular, human errors. Two types of human error modes are typically used: errors of omission and errors of commission. An error of omission (EOM) is the failure to initiate performance of a system required action (e.g., skipping a procedural step or an entire task). An error of commission (ECOM) is the incorrect performance of a system required action, given that an action is attempted, or the performance of some action that is not required by the system and that has the potential for contributing to a system failure (e.g., selection of a wrong control, a sequence error, a timing error, etc.).

Accident sequence modelling is used to ensure that the response of the plant's systems and operators to an IE is reflected in the assessment of CDF in such a way that: significant operator actions, mitigation systems, and phenomena that can alter sequences are appropriately included in the accident sequence (AS) model; plant-specific dependencies are reflected in the accident sequence structure; dependencies on the IE, functional dependencies, human interactions, environmental impact, etc. are reflected in the model; the individual function successes, mission times, and time windows for operator actions should all realistically reflects plant operation; and end states are clearly defined to be either a core damage or successful prevention with the capability to support the interface between Level 1 and Level 2 PSAs.

The primary objective of the PSA is to gain a complete understanding of the factors that are dominant contributors to NPP risk. A secondary objective is to ensure that assumptions, limitations, and quality of the study under consideration could not bias the results and insights gained from the PSA results. Usual dominant risk contributors include post-initiator human errors, common-cause failures, test and maintenance unavailability, and equipment performance. PSA results interpretation and insight development is based on the following: importance analysis; uncertainty analysis; and sensitivity analysis. A risk contributor's importance is determined by its location in the integrated logic structure and its probability. There are several levels of risk contributors: initiating events, classes of basic events (e.g., human errors, etc.), individual basic events, etc. The process for identifying risk contribution is as follows: combine all accident sequence cut sets into a single list, sort by decreasing frequency, and then examine the most likely ones (typically 99% of the total core damage frequency); partition the total core damage frequency by initiating event; and calculate the percentage of the total core damage frequency due to certain classes of events (e.g., human errors, common-cause failures, independent failures, specific systems, etc.).

Importance measures (IMs) include the Fussell-Vesely importance (FV) (an indication of the fraction of the minimal cut sets that involves the cut sets containing the basic event of concern); the risk achievement worth (RAW) (the maximum level to which CDF could increase by assuming that a given component is failed and not available); the risk reduction worth (RRW) (an indication of how much the CDF would be reduced if the specific event probability equaled zero, normally corresponding to a totally reliable piece of equipment); and the Birnbaum importance measure (B) (an indication of the sensitivity of the CDF with respect to the basic event of concern).

With regard to the uncertainty analysis, the probabilities developed in a PSA carry uncertainty from two sources: stochastic or random behavior (aleatory uncertainty) and lack of adequate knowledge (epistemic or “state-of-knowledge” uncertainty). Sources of stochastic or random behavior are inherent in the data (e.g., failure rates, human error probabilities, IE frequencies, etc.). However, aleatory uncertainty can be reduced as more statistical data are collected. With regard to lack of adequate knowledge, this includes assumptions and simplifications, component failure (e.g., based on temperature/humidity limits), pressurize thermal shock, accident progression, etc. Epistemic uncertainties can be reduced or eliminated as more data are collected from research. Before making conclusions about NPP risk or proposing NPP modifications to reduce risk, the epistemic or “state-of-knowledge” uncertainty in the PSA results should be considered together with data uncertainty. Sensitivity studies are the main approach for assessing these uncertainties.

The above broadly outlines the development of a typical Level 1 PSA, which Level 1 PSAAs are presently used throughout the world to model risks and reliability associated with nuclear power plants. The primary output of the PSA is the CDF. Although Living PSAs, as discussed above, expand the conventional PSA by allowing the PSA to be updated, such Living PSAs typically do not update the basic PSA model in real time. Although PSA analysis has become a necessary process in the operation of every NPP, real time updating to the model for real time risk monitoring and mitigation has proven difficult. Further, a conventional PSA (or Living PSA) does not take into account additional information based on patterns or trends in historical data. Thus, a method for performing real-time probabilistic safety assessments for nuclear power plants solving the aforementioned problems is desired.

### SUMMARY

The method for performing real-time probabilistic safety assessments for nuclear power plants is an artificially intelligent, self-updating Living probabilistic safety assessment (PSA). An initial probabilistic safety assessment model is developed for a particular nuclear power plant. As discussed above, the initial PSA analyzes the risk associated with operating the nuclear power plant, with the output results expressed in terms of various metrics related to the different levels of damage to the nuclear power plant, including the core damage frequency (CDF). In the present method, the development of the PSA is the first step and the generation of the set of PSA results therefrom is the second step.

In the third step, a simulation of the nuclear power plant is developed and, as a fourth step, real-time parameters are measured from the nuclear power plant using any suitable type of sensors and/or monitors located within the plant. As a non-limiting example, sensors and/or monitors may be provided for real-time measurement of temperature, pressure, flow rates, and any other desired system parameters throughout the plant.

As a fifth step, feature extraction is performed on the results of the probabilistic safety assessment model combined with corresponding results from the simulation and the measured real-time parameters. The extracted features correspond to the measured real-time parameters; i.e., in the non-limiting example given above, if the measured parameters are temperature, pressure and flow rate, then the extracted features from the PSA model and the simulation will also be temperature, pressure and flow rate.

As a sixth step, a set of system state labels is generated. The members of the set of system state labels each include an indication of system state function at a unique time. As a non-limiting example, for a particular component or sub-system of the nuclear power plant, or for the entire plant itself, labels may be generated to indicate that the component, sub-system or entire system is operating normally, experiencing a fault, or is in a degraded state.

In a seventh step, an updated probabilistic safety assessment model is developed using the extracted features and the set of system state labels as training data for a machine learning algorithm. Any suitable type of machine learning technique may be used to develop the updated PSA based on the training data, including, but not limited to, MATLAB, random forest, support vector machines (SVMs), or one or more types of neural networks. The initial probabilistic safety assessment model is then replaced with the updated probabilistic safety assessment model and the process returns to the second step for continuous output of updated results. Prior to the step of replacing the initial probabilistic safety assessment model with the updated probabilistic safety assessment model, the updated probabilistic safety assessment model may first go through a validation process.

These and other features of the present subject matter will become readily apparent upon further review of the following specification.

### BRIEF DESCRIPTION OF DRAWINGS

FIG. 1 is a flow diagram illustrating steps of a method for performing real-time probabilistic safety assessments for nuclear power plants.

FIG. 2 is a block diagram illustrating development of a conventional Level 1 probabilistic safety assessment model.

Similar reference characters denote corresponding features consistently throughout the attached drawings.

### DETAILED DESCRIPTION

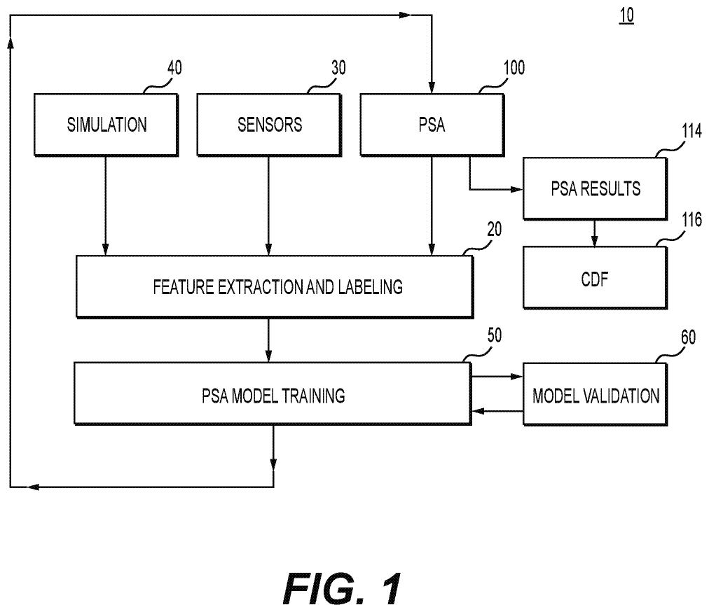

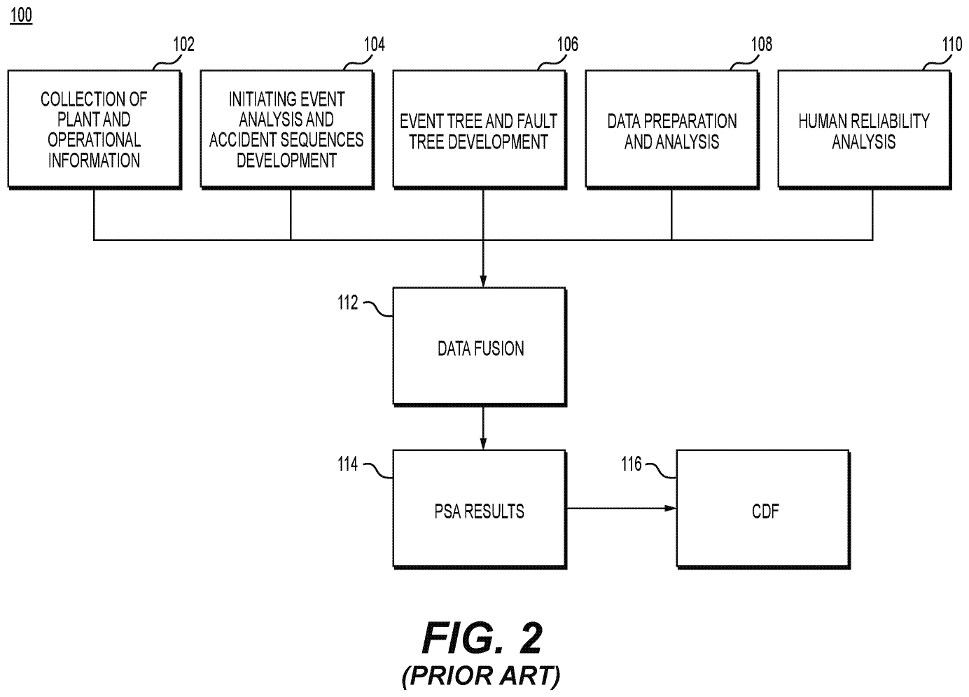

The method for performing real-time probabilistic safety assessments for nuclear power plants 10 is an artificially intelligent, self-updating Living probabilistic safety assessment (PSA). An initial probabilistic safety assessment model is developed for a particular nuclear power plant. As a non-limiting example, a conventional PSA or Living PSA, such as the AIMS-PSA developed by Sang Hoon Han et al., may be applied to a particular type of nuclear power plant, such as Advanced Power Reactor 1400 (APR1400) developed by the Korea Electric Power Corporation (KEPCO), which is a third-generation pressurized water reactor (PWR). As discussed above with respect to FIG. 2, the initial PSA (shown generally as 100 in FIG. 1) analyzes the risk associated with operating the nuclear power plant, with the output results 114 expressed in terms of various metrics related to the different levels of damage to the nuclear power plant, including the core damage frequency (CDF) 116. In the present method, the development of the PSA 100 is the first step and the generation of the set of PSA results 114 therefrom is the second step.

In the third step, a simulation of the nuclear power plant 40 is developed. In the non-limiting example above, the exemplary nuclear power plant is a pressurized water reactor, thus a generic pressurized water reactor (GPWR) simulator can be developed in the form of a software tool that simulates the behavior and performance of a GPWR in real-time. In this non-limiting example, the GPWR simulator may be designed to provide a virtual environment for training nuclear power plant operators and engineers in the safe and effective operation of a GPWR. The simulator may use any suitable type of modeling and simulation techniques to replicate the behavior of the reactor core, coolant system and other components of a GPWR, including control systems, pumps, valves, safety systems, etc.

As a fourth step, real-time parameters are measured from the nuclear power plant using any suitable type of sensors 30 and/or monitors located within the plant. As a non-limiting example, sensors and/or monitors may be provided for real-time measurement of temperature, pressure, flow rates, and any other desired system parameters throughout the plant.

As a fifth step, feature extraction is performed on the results of the probabilistic safety assessment model combined with corresponding results from the simulation and the measured real-time parameters. The extracted features correspond to the measured real-time parameters; i.e., in the non-limiting example given above, if the measured parameters are temperature, pressure and flow rate, then the extracted features from the PSA model and the simulation will also be temperature, pressure and flow rate.

As a sixth step, a set of system state labels is generated. The members of the set of system state labels each include an indication of system state function at a unique time. As a non-limiting example, for a particular component or sub-system of the nuclear power plant, or for the entire plant itself, labels may be generated to indicate that the component, sub-system or entire system is operating normally, experiencing a fault, or is in a degraded state. The feature extraction and labeling may be performed using any suitable type of feature extraction software or the like, and may be performed together or simultaneously, as indicated generally as 20 in FIG. 1. Non-limiting examples of presently available feature extraction and labeling software and techniques include MATLAB, SciLab, NumPy, scikit-learn, the R language, and principal component analysis.

In a seventh step, an updated probabilistic safety assessment model is developed using the extracted features and the set of system state labels as training data for a machine learning algorithm (shown generally as 50 in FIG. 1). Any suitable type of machine learning technique may be used to develop the updated PSA based on the training data, including, but not limited to, MATLAB, random forest, support vector machines (SVMs), or one or more types of neural networks.

The initial probabilistic safety assessment model 100 is then replaced with the updated probabilistic safety assessment model and the process returns to the second step for continuous output of updated results. Prior to the step of replacing the initial probabilistic safety assessment model 100 with the updated probabilistic safety assessment model, the updated probabilistic safety assessment model may first go through a validation process (shown generally as 60 in FIG. 1). During validation, the accuracy and robustness of the updated probabilistic safety assessment model can be tested on a separate set of data to ensure that it can generalize to new situations. Once the updated probabilistic safety assessment model is validated, it can then replace the initial PSA.

It should be understood that all of the necessary calculations, modeling, simulation, processing and the like may be performed using any suitable type of computer, computer system, computer network, neural network, generalized controller, generalized control system, processor, microprocessor or combinations or pluralities thereof, as is conventionally known.

It is to be understood that the method for performing real-time probabilistic safety assessments for nuclear power plants is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method for performing real-time probabilistic safety assessments to generate a risk perspective in long-term planning of design and operational changes for nuclear power plants, comprising the steps of:
a) developing an initial probabilistic safety assessment model for a nuclear power plant, wherein the initial probabilistic safety assessment model is a living AIMS-PSA model developed using existing plant information of a nuclear power plant, plant documentation of said nuclear power plant, and analysts' assumptions in an absence of said existing plant information and plant documentation of said nuclear power plant;
b) generating a set of probabilistic safety assessment results;
c) developing a simulation of the nuclear power plant;
d) measuring real-time parameters from the nuclear power plant;
e) performing feature extraction on results of the probabilistic safety assessment model combined with corresponding results from the simulation and the measured real-time parameters, wherein extracted features correspond to the measured real-time parameters;
f) generating a set of system state labels, wherein members of the set of system state labels each comprise an indication of system state function at a unique time;
g) developing an updated probabilistic safety assessment model using the extracted features and the set of system state labels as training data for a machine learning algorithm; and
h) replacing the initial probabilistic safety assessment model with the updated probabilistic safety assessment model and returning to step b), wherein the updated probabilistic safety assessment model is a living AIMS-PSA model that is used in conjunction with a safety/risk monitor, said safety/risk monitor showing a current risk state based on an actual nuclear power plant configuration and current tests in progress to ensure any needed adjustments are made for continued safe operation of the nuclear power plant.

2. The method for performing real-time probabilistic safety assessments for nuclear power plants as recited in claim 1, further comprising the step of validating the updated probabilistic safety assessment model prior to the step of replacing the initial probabilistic safety assessment model with the updated probabilistic safety assessment model.

3. The method for performing real-time probabilistic safety assessments for nuclear power plants as recited in claim 1, wherein the nuclear power plant comprises a pressurized water reactor.

4. The method for performing real-time probabilistic safety assessments for nuclear power plants as recited in claim 1, wherein the probabilistic safety assessment results include core damage frequency associated with the nuclear power plant.

5. A system for performing real-time probabilistic safety assessments to generate a risk perspective in long-term planning of design and operational changes for nuclear power plants, comprising:
at least one sensor for measuring real-time parameters from a nuclear power plant; and
at least one controller configured to:
develop an initial probabilistic safety assessment model for the nuclear power plant, wherein the initial probabilistic safety assessment model is a living AIMS-PSA model developed using existing plant information of a nuclear power plant, plant documentation of said nuclear power plant, and analysts' assumptions in an absence of said existing plant information and plant documentation of said nuclear power plant;
generate a set of probabilistic safety assessment results;
develop a simulation of the nuclear power plant;
perform feature extraction on results of the probabilistic safety assessment model combined with corresponding results from the simulation and the measured real-time parameters, wherein extracted features correspond to the measured real-time parameters;
generate a set of system state labels, wherein members of the set of system state labels each comprise an indication of system state function at a unique time;
develop an updated probabilistic safety assessment model using the extracted features and the set of system state labels as training data for a machine learning algorithm; and
replace the initial probabilistic safety assessment model with the updated probabilistic safety assessment model), wherein the updated probabilistic safety assessment model is a living AIMS-PSA model that is used in conjunction with a safety/risk monitor, said safety/risk monitor being designed to show a current risk state based on an actual nuclear power plant configuration and current tests in progress to ensure any needed adjustment are made for continued safe operation of the nuclear power plant.

6. The system for performing real-time probabilistic safety assessments for nuclear power plants as recited in claim 5, wherein the at least one controller is further configured to validate the updated probabilistic safety assessment model.

7. The system for performing real-time probabilistic safety assessments for nuclear power plants as recited in claim 5, wherein the nuclear power plant comprises a pressurized water reactor.

8. The system for performing real-time probabilistic safety assessments for nuclear power plants as recited in claim 5, wherein the probabilistic safety assessment results include core damage frequency associated with the nuclear power plant.
